(19) United States
(12) Patent Application Publication
(10) Pub. No.: US 2002/0087498 A1
(43) Pub. Date: Jul. 4, 2002

(54) Autonomous behavior decision control system for an electronic device

(76) Inventor: Makoto Yoshida, Iwata (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/917,293

(22) Filed: Jul. 27, 2001

(30) Foreign Application Priority Data
Jul. 27, 2000 (JP) 2000-226287

(51) Int. Cl. G06F 17/00

(52) U.S. Cl. 706/45; 706/1

(57) ABSTRACT

An electronic device, such as a pet robot, having an autonomic function that facilitates the development of certain personalities based on user inputs is described. Controls allow the user to specify an initial personality or to re-initialize the pet robot with a new personality. The selected personality is used as a starting point, and the personality of the pet robot develops and changes automatically after that until such time as the user decides to re-initialize the personality or select a new personality for the pet robot. In one embodiment the user selects a single personality for the pet robot. In one embodiment the user selects a plurality of personalities for the pet robot and an initialization module builds a composite personality by combining the plural personalities into a single composite personality.

### REFERENCE TO RELATED APPLICATION

The present application claims foreign priority benefit of Japanese Application No. P17022, filed Jul. 27, 2000, the contents of which is hereby incorporated by reference in its entirety.

### BACKGROUND OF THE INVENTION

1. Field of the Invention

The present invention relates to an electronic device having autonomic (self-regulatory) emotion and personality functions in which personalities can be modified depending on external factors such as initial conditions and how a user interacts with the electronic device.

2. Description of the Related Art

A conventional pet robot is a system in which information, such as surrounding situations or movements of a pet owner (a user of the pet robot), is acquired with an electronic camera or a microphone. Information about the owner is extracted from the acquired information by using image recognition and/or voice recognition. Emotions are produced based on the extracted information, and actions are determined based on the emotions.

For example, the pet robot signals hunger and fatigue to the user by displaying various actions to demand pet food or the like. Over time, the pet robot develops a personality based on the user's reactions and how the owner responds to the pet robot.

At a time of purchase, the pet robot is not provided with a specific personality. Thus, the user can enjoy the process of personality-development in the pet robot. However, some users are impatient, and become bored with the pet robot while waiting for the pet robot to develop the personality desired by the user.

This problem is not only necessarily limited to pet robots and can apply to electronic devices that facilitate the development of certain characters/personalities of other electronic pet-type simulators.

### SUMMARY OF THE INVENTION

The present invention solves these and other problems by providing an electronic device, such as a pet robot, having an autonomic function that facilitates the development of certain personalities based on user inputs that allow the user to specify an initial personality (or to re-initialize the pet robot with a new personality). The selected personality is a starting point and the personality of the pet robot develops and changes automatically after that until such time as the user decides to re-initialize the personality or select a new personality for the pet robot.

The user can set up the pet robot with personalities of the user's own preference. Since the user can select a personality, rather than wait for a personality to develop, the user is less likely to get bored with the pet robot. In one embodiment, the user selects a personality from a list of personalities. In one embodiment, the user selects a plurality of personalities from a list of personalities and an initialization module builds a composite personality from the plurality of personalities. Thus, with a combination of plural personalities, the user can obtain a wider selection to satisfy the user's specific preferences.

Once the personality has been initialized, the personality of the pet robot continues to develop from the starting personality provided during initialization. Stored plural personality information in the pet robot can be rewritten partially or entirely. Thus, the user has much control over the process of selecting personalities for the robot.

In one embodiment, the user can connect the pet robot to a computer network to rewrite the currently stored personality information. Thereafter, the user can easily change the personality at any time. In one embodiment, the user can connect the pet robot to the Internet to download personalities from a server. In one embodiment, the pet robot includes an internal modem for making an Internet connection through a telephone line. In one embodiment, the pet robot includes a connector for connecting to an external modem.

The user can develop initial personalities of the user's own preference on pets so that the user is able to play with the pet robot having a desired personality without waiting for a desired personality to develop.

### BRIEF DESCRIPTION OF THE DRAWINGS

These and other features of the invention will now be described with reference to the drawings summarized below. These drawings and the associated description are provided to illustrate preferred embodiments of the invention, and not to limit the scope of the invention.

FIG. 1 is a block diagram showing the structure of a pet robot or other electronic device.

FIG. 2 is a block diagram showing processing of information in the pet robot or other electronic device.

### DETAILED DESCRIPTION

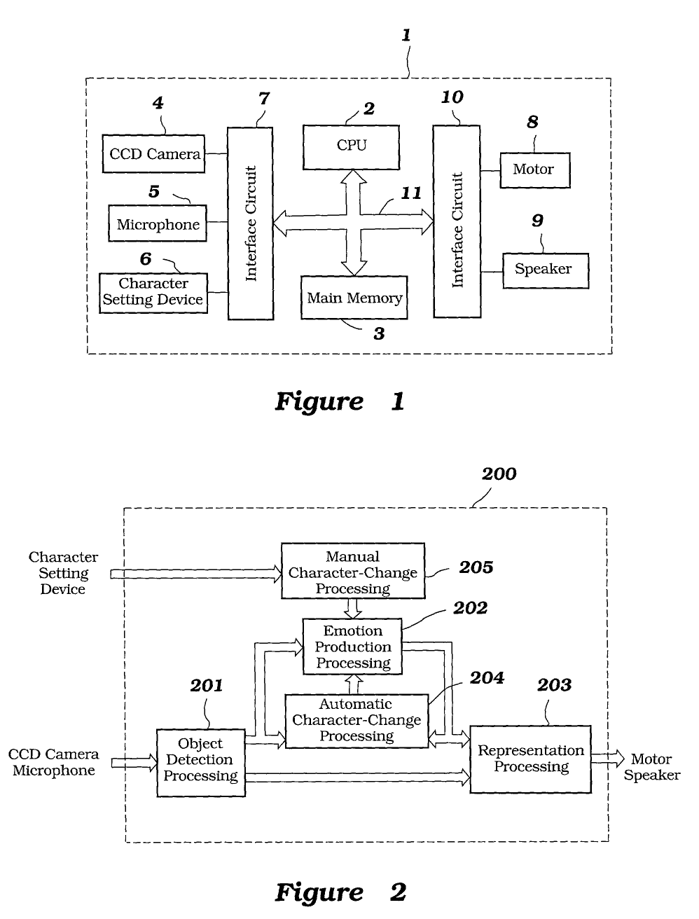

FIG. 1 is a block diagram showing the structure of a pet robot 1. The pet robot 1 includes a Central Processing Unit (CPU) 2, a main memory 3 for storing programs such as an operating system and other information, an interface circuit 7 for input devices such as an electronic camera 4, a microphone 5, and a personality-setting module 6. In one embodiment, the personality-setting module 6 includes user-operable personality-setting controls. In one embodiment, the personality-setting module 6 includes a computer network interface, such as, for example, a modem, an ethernet port, a Universal Serial Bus (USB) port, a radio-frequency link (e.g., a Bluetooth link), etc. The personality-setting module 6 allow the user to set up or select personalities for the pet robot 1. The pet robot 1 also includes an interface circuit 19 for output devices such as a motor system 8 and a speaker 9. The pet robot 1 also includes a system bus 11 for connecting the CPU 2, the main memory 3 and the interface circuits 7 and 10.

The personality-setting module 6 can be equipped with switches corresponding to personalities that can be adopted by the pet robot 1. Further, The personality-setting module 6 can be equipped with a connection terminal (e.g. a data bus connection) to allow connection of the pet robot 1 to an external device for setting up the personalities of the pet robot 1. In one embodiment, the personality-setting controls are omitted and the user uses the connection terminal and an external device to configure the personality of the pet robot 1. If only the connection terminal is chosen, the pet robot 1 only need be connected to the external device when the user determines the personality of the pet robot 1, thus reducing the size of the pet robot 1. In one embodiment, the external device is a computer modem. In one embodiment, the external device is a computer or computer network. In one embodiment, the external device is a custom device configured to program personalities into the pet robot 1.

The user of the pet robot 1 activates a pet robot control program stored in the pet robot 1. The pet robot control program is executed by the CPU 2.

FIG. 2 is a block diagram of a pet robot control program 200, the pet robot control program 200 includes an object-detection module 201 for detecting user's actions and the surrounding environment. Data from external sensors, such as the electronic camera 4 and the microphone 5 are provided to the detection-processing module. The detection-processing module 201 provides detection data to an emotion-producing module 202 for producing emotions based at least in part on the detection data. The detection-processing module also provides detection data to an expression processing module 203 that selects what kind of action is needed and produces one or more control signals based on the detection data and on emotion data produced by the emotion-producing module 202. The control signals are provided to control the motor system 8 and the speaker 9. The detection data and the emotion data are also provided to an automatic personality-modification module 204, which produces character change data that is provided to the emotion-producing module 202. Data from the user personality-setting module 6 is provided to a manual personality modification module 205 for modifying the equations used for producing emotions in the emotion-producing module 202 (based on inputs from the personality-setting module 6).

The object-detection module 201 is arranged to detect various types of information such as the user's actions and/or voice when the user is interacting with the pet robot 1. The object-detection module detects surrounding objects and temperatures based on data provided by the electronic camera 4, microphone 5, and other sensors, such as, for example, a temperature sensor.

The emotion-producing module 202 is configured to produce emotions for the pet robot 1 based on detection results from the object-detection module 201 with an equation that computes parameters expressing emotions. The emotions of the pet robot 1 includes for example “anger” “sadness,” “pleasure,” “fear,” “surprise” and “hatred”. These emotions are displayed according the strength of each emotion, as represented by parameters computed in the emotion module 202.

The expression module 203 is arranged to select actions by referring to a parameter showing an emotion computed by the emotion-producing module 202 and to produce a control signal in order to perform such action selected by the detection result of the object-detection module 201. The control signal is provided to output devices such as the motor system 8 to produce movements (corresponding to front paws, hind legs, torso, head, etc.) and the speaker 9 to produce sounds (e.g., barks, growls, etc.) The pet robot 1 can produce expressions such as “bite,” “bark,” “run,” “cry,” “lie down” etc. These actions are regulated by lower limit and upper limit values of parameters reflecting the strength of each emotion. For example, a “biting” action is selected when a parameter indicating “anger” is in the range 90-100 and a parameter indicating “sadness” is in the range 0-20.

The automatic personality-modification module 204 is arranged to read emotion weighting values, and modify those weighting values based on inputs from the object-detection module 201 and inputs from the emotion-producing module 202. The emotion weighting values (also known as weights, or weighting coefficients) are used by equations in the emotion-producing module 202 to compute the emotion parameters of the pet robot 1. Thus, modifying the emotion weighting values changes the emotions produced (and thus the personality) of the pet robot 1. For example, when a parameter showing “anger” is always great because of constant scolding by the owner, the weighting value corresponding to anger is increased. This changes the equations producing emotions so that a computing result of the parameter showing “anger” is multiplied by larger weighting factor, whereupon the personality of the pet robot 1 becomes “short-tempered”. On the other hand, when the parameter showing “anger” is always small because of constant praise by the owner, the weighting factor for anger is decreased, whereupon the personality of the pet robot 1 becomes “mild”.

The manual personality modification module 205 reads out an emotion weighting factor from a database based on a setting or selection by the user on the personality-setting module 6. This modifies the emotion-producing equations so that the user can control the personality of the pet robot 1. For example, when a “short-tempered personality” is selected in the personality-setting module 6, an equation for producing emotions is modified so that the weighting factor for “anger” is increased. Since the weighting factor is increased, the personality of the pet robot 1 becomes “short-tempered”. On the other hand, when a “mild personality” is selected in the personality-setting module 6, the equation for producing emotions is modified so that the computing weighting factor for expressing “anger” is decreased. Since the parameter becomes smaller, the personality of the pet robot 1 displays a “mild personality”.

With the manual personality modification module 205, since the user is able to set up a preferable personality at time of purchase, the user can start playing with the pet robot 1 having personality of his/her own preference. Thus the user is less likely to become bored and impatient during the pet robot's personality-development period.

Furthermore, when multiple personalities are set up simultaneously in the personality-setting module 6, predetermined values corresponding to each selected personality are read out respectively from the main memory 2. Then, the equation for producing emotions is modified so that the computing result of the weighting factors showing emotions are multiplied by said predetermined values individually, whereby the pet robot 1 has combined multiple personalities. With this arrangement, the personalities of the pet robot 1 are combined to meet user's specific preference.

In one embodiment, the main memory 2 stores the personality information data, the personality-setting module 6 is used to select personality information, and the manual personality-modification module 205 updates the personality information data based on inputs from the user. One of ordinary skill in the art will recognize that other techniques, such as connecting the pet robot 1 to a computer or other external device can be used to set up personalities.

Moreover, although described in terms of a pet robot, the personality-setting features disclosed herein are not limited to a pet robot. The personality-setting features can be also applied to other electronic pet-type devices such as upbringing or parenting simulation game machines.

Furthermore, the main memory 2 can be rewritten partially or entirely in order to change predetermined values corresponding to each personality. For example, the electronic device can be equipped with a connection terminal to a computer network (e.g. a telecommunication line, an Internet connection, an ethernet connection, a computer connection, etc.) to which a server for storing plural personality information is connected. When the computer network is connected to the connection terminal, the plural personality information currently stored in the main memory 2 can be partially or entirely rewritten by referring to personality information stored in the server and copying the information from the server to the pet robot 1.

Although described above in connection with the particular embodiments of the present invention, it should be understood that the descriptions of the embodiments are illustrative of the invention and are not intended to be limiting. Various modifications and applications can occur to those skilled in the art without departing from the true spirit and scope of the invention as defined in the appended claims.

What is claimed is:

1. An electronic device having an autonomic self-regulatory function in which personalities are modified depending on external factors, comprising: a personality information database for storing information relating to plural personalities, a manual personality selecting module for allowing a user to choose a desired personality from said database as a selected personality, said manual personality selecting module configured to set said selected personality as an initial personality.

2. The electronic device in claim 1, wherein said manual personality selecting module is adapted to allow the user to select a plurality of personalities from said personality information database, and said manual personality selecting module configured to set said initial personality based on said plurality of personalities.

3. The electronic device in claim 1, wherein said manual personality selecting module is adapted to partially or entirely rewrite said personality database.

4. The electronic device in claim 1, further comprising a connection terminal connectable to a computer network to allow the user to partially or entirely rewrite said personality information database using new personality information obtained from said computer network.

5. The electronic device in claim 1, wherein a personality of said electronic device is initially based on said initial personality, said electronic device further comprising an automatic personality setting module configured to update said personality of said electronic device in response to external inputs such that over time said personality of said electronic device diverges from said initial personality.

6. The electronic device in claim 1, wherein said personality database comprises weighting factors for various emotions exhibited by the electronic device.

7. The electronic device in claim 1, wherein said initial personality comprises a set of initial weights for one or more emotions exhibited by the electronic device.

8. The electronic device in claim 1, further comprising a modem to allow said electronic device to download new personality information to said personality database from a computer network.

9. The electronic device in claim 1, further comprising a computer network interface to allow said electronic device to download new personality information to said personality database from a computer network.

10. The electronic device in claim 1, further comprising a data interface to allow said electronic device to download new personality information to said personality database from an external device.

11. The electronic device in claim 1, wherein a personality of said electronic device is initially based on one or more emotion weights specified by said initial personality, said electronic device further comprising an automatic personality setting module configured to update said one or more emotion weights in response to external inputs such that over time said personality of said electronic device diverges from said initial personality.

12. An apparatus, comprising: a personality information database for storing information relating to plural personalities; means for choosing a desired personality from said database as a selected personality; and means for setting said selected personality as an initial personality.

13. The apparatus of claim 12, wherein said means for choosing is adapted to allow a user to select a plurality of personalities from said personality information database, and said means for setting sets said initial personality based on a combination of said plurality of personalities.

14. The apparatus of claim 12, wherein said means for choosing is further adapted to partially or entirely rewrite said personality database.

15. The apparatus of claim 12, further comprising means for connecting to a computer network to allow the user to partially or entirely rewrite said personality information database using new personality information obtained from said computer network.

16. The apparatus of claim 12, wherein a personality of said electronic device is initially based on said initial personality, said electronic device further comprising means for automatically updating said personality such that over time said personality of said electronic device diverges from said initial personality.

17. The apparatus of claim 12, wherein said personality database comprises weighting factors for various emotions exhibited by the electronic device.

18. The apparatus of claim 12, wherein said initial personality comprises a set of initial weight coefficients for one or more emotions exhibited by the electronic device.

19. The apparatus of claim 1, wherein a personality of said electronic device is initially based on one or more emotion weighting coefficients specified by said initial personality, said electronic device further comprising an automatic personality setting module configured to update said one or more emotion weighting coefficients in response to external inputs such that over time said personality of said electronic device diverges from said initial personality.

20. A method for training an electronic device having an autonomic self-regulatory function in which personalities are modified depending on external factors, comprising: using user inputs to select an initial personality from a personality information database; initializing a personality of said electronic device using said initial personality; and updating said personality of said electronic device in response to external training inputs such that over time said personality of said electronic device diverges from said initial personality.

21. A method for training an electronic device having an autonomic self-regulatory function in which personalities are modified depending on external factors, comprising: using user inputs to select one or more initial emotion weights from a personality information database; initializing a personality of said electronic device using said one or more initial emotion weights to initialize personality emotion weights; and updating said personality emotion weights in response to external training inputs such that over time said personality emotion weights diverge from said initial emotion weights.

22. The method of claim 21, further comprising downloading at least a portion of said personality information database from a computer network.

23. The method of claim 21, further comprising downloading at least a portion of said personality information database from an external device.
